(19) United States
(12) Patent Application Publication
(10) Pub. No.: US 2016/0029214 A1
(43) Pub. Date: Jan. 28, 2016

(54) HOME CONTROL GATEWAY AND HOME CONTROL NETWORK CONNECTION METHOD THEREOF

(71) Applicant: proeasy network solutions co., LTD., Hsinchu County (TW)

(72) Inventor: Hsing-Hung Lu, Hsinchu County (TW)

(21) Appl. No.: 14/489,479

(22) Filed: Sep. 18, 2014

(30) Foreign Application Priority Data
Jul. 25, 2014 (TW) 103125526

(51) Int. Cl. H04W 12/06; H04M 1/57

(52) U.S. Cl. CPC H04W 12/06; H04M 1/57

(57) ABSTRACT

A home control gateway and a home control network connection method for remote home controlling are provided. The method includes receiving a calling signal from a mobile device through a mobile phone network, identifying a phone number according to the calling signal, verifying whether the phone number exists in a database of the home control gateway, generating a token, and transferring the token to the mobile device as a short message. The method further includes, when receiving a connection request from the mobile device by the short message with the token, allowing building a communication channel with the mobile device.

### CROSS-REFERENCE TO RELATED APPLICATION

This application claims the priority benefit of Taiwan application serial no. 103125526, filed on Jul. 25, 2014. The entirety of the above-mentioned patent application is hereby incorporated by reference herein and made a part of this specification.

### BACKGROUND OF THE INVENTION

1. Field of the Invention

The invention relates to a home control technique and more particularly relates to a home control gateway and a home control network connection method thereof.

2. Description of Related Art

The computer industry has flourished for nearly half the century. Thanks to the progress of this technology, automation equipment, such as washing machines, dishwashers, and sweeping robots, becomes common in our daily life. Due to the change of population structure and work style of the society, the manpower that used to be spent on household affairs is gradually replaced by machines. More and more integration solutions for integrating, managing, and controlling a variety of household appliances or equipment, such as lights, television, security system, air conditioning, and audiovisual stereo, are being introduced along with new terms such as smart home, digit home, electronic home, and home automation.

The home automation control system integrates household appliances, such as television, electric rice cooker, air conditioner, refrigerator, gas switch, alarm system, security system, and surveillance system, by means of automated equipment, computer software, and applications, so as to improve home comfort and security. Generally, the home automation control system includes a control system and a control host. The user can give a control order through the control system and then drive the appliances through the control host. In addition, through a variety of wireless transmission technology, such as GPRS, WiFi, WiMAX, 3G, and 4G, the user can connect to the Internet via the network connection function provided by devices, such as a mobile phone or a laptop computer, to control the household appliances remotely or activate the security system to check on the house even when the user is on a business trip or vacation, which is more flexible and convenient for the user.

Remote control is flexible and convenient but it also raises concern about security, e.g. verification of the user identity. Generally, the control host authorizes the user to perform control only after verifying the user's identity through a verification mechanism, such that the user can perform remote control. A common method is that the home control system host provides a website for the user to input correct user name and password, and once the user name and password are verified, the user is allowed to control the home control system host. However, the user may forget the user name or password from time to time, or the user name or password might be stolen. Therefore, the invention is directed to providing the user a convenient, secure, simple, and easy way to perform remote control more simply and securely.

### SUMMARY OF THE INVENTION

The invention provides a home control gateway and a home control network connection method thereof, adapted for identifying the user's phone number and generating a unique token, such that a mobile communication device of the user can establish a communication channel with the home control gateway by the token for performing remote home control securely.

An exemplary embodiment of the invention provides a home control gateway. The home control gateway includes: a microprocessor unit, a first communication circuit, a second communication circuit, a gateway filter circuit, and a storage circuit. The first communication circuit is coupled to the microprocessor unit and configured to receive a first calling signal from a mobile communication device through a mobile phone network. The storage circuit is coupled to the microprocessor unit and configured to store a mobile communication device number database. The first communication circuit is further configured to identify a phone number of the mobile communication device according to the first calling signal of the mobile communication device, and the gateway filter circuit determines whether the phone number of the mobile communication device exists in the mobile communication device number database. If the phone number exists in the mobile communication device number database, the gateway filter circuit generates a token, and the first communication circuit generates a short message according to the token and transmits the short message to the mobile communication device through the mobile phone network. If the second communication circuit receives a connection request including the token from the mobile communication device through an Internet, the gateway filter circuit allows the second communication circuit to establish a communication channel with the mobile communication device.

In an exemplary embodiment of the invention, after the mobile communication device establishes the communication channel with the second communication circuit through the Internet, the first communication circuit is further configured to receive a second calling signal from the mobile communication device through the mobile phone network. In addition, the gateway filter circuit cuts the communication channel established between the mobile communication device and the second communication circuit through the Internet in response to the second calling signal.

In an exemplary embodiment of the invention, after the mobile communication device establishes the communication channel with the second communication circuit through the Internet, the first communication circuit is further configured to receive a short message from the mobile communication device through the mobile phone network. In addition, the gateway filter circuit cuts the communication channel established between the mobile communication device and the second communication circuit through the Internet in response to the short message from the mobile communication device.

In an exemplary embodiment of the invention, the gateway filter circuit generates the token randomly or according to a fixed rule.

In an exemplary embodiment of the invention, the first communication circuit is further configured to receive a short message from a master mobile communication device through the mobile phone network, wherein the short message from the master mobile communication device includes at least one other phone number. In addition, the gateway filter circuit adds the at least one other phone number in the short message from the master mobile communication device to the mobile communication device number database.

An exemplary embodiment of the invention provides a home control network connection method adapted to be executed by the home control gateway. The home control network connection method includes: receiving a first calling signal from a mobile communication device through a mobile phone network; identifying a phone number of the mobile communication device according to the first calling signal of the mobile communication device; and determining whether the phone number of the mobile communication device exists in a mobile communication device number database. The home control network connection method further includes: generating a token, generating a short message according to the token, and transmitting the short message to the mobile communication device through the mobile phone network if the phone number exists in the mobile communication device number database. The home control network connection method further includes: allowing the mobile communication device to establish a communication channel if a connection request including the token is received from the mobile communication device through an Internet.

In an exemplary embodiment of the invention, the home control network connection method further includes: receiving a second calling signal from the mobile communication device through the mobile phone network after the mobile communication device establishes the communication channel with the second communication device through the Internet; and cutting the communication channel established between the mobile communication device and the second communication circuit through the Internet in response to the second calling signal.

In an exemplary embodiment of the invention, the home control network connection method further includes: receiving a short message from the mobile communication device through the mobile phone network after the mobile communication device establishes the communication channel with the second communication circuit through the Internet; and cutting the communication channel established between the mobile communication device and the second communication circuit through the Internet in response to the short message from the mobile communication device.

In an exemplary embodiment of the invention, the step of generating the token includes generating the token randomly or according to a fixed rule.

In an exemplary embodiment of the invention, the home control network connection method further includes: receiving a short message, which includes at least one other phone number, from a master mobile communication device through the mobile phone network; and adding the at least one other phone number in the short message from the master mobile communication device to the mobile communication device number database.

Based on the above, the exemplary embodiments of the invention provide a home control gateway and a home control network connection method, wherein the phone number of the user is verified for the home control gateway to generate a unique token for establishing a communication channel, such that the user can perform remote home control through the user's mobile communication device. Accordingly, the user can control household appliances remotely in a simple, easy, convenient, and secure way.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic diagram illustrating remote home control according to an exemplary embodiment of the invention.

FIG. 2 is a block diagram illustrating a home control gateway according to an exemplary embodiment of the invention.

FIG. 3 is a flowchart illustrating a home control network connection method according to an exemplary embodiment of the invention.

### DESCRIPTION OF THE EMBODIMENTS

As the Internet technology matures, if the processes of verifying user identity are simplified and a secure remote control method is available, control of an automated home control system would be more convenient and easy. The invention is developed on the basis of the above concept.

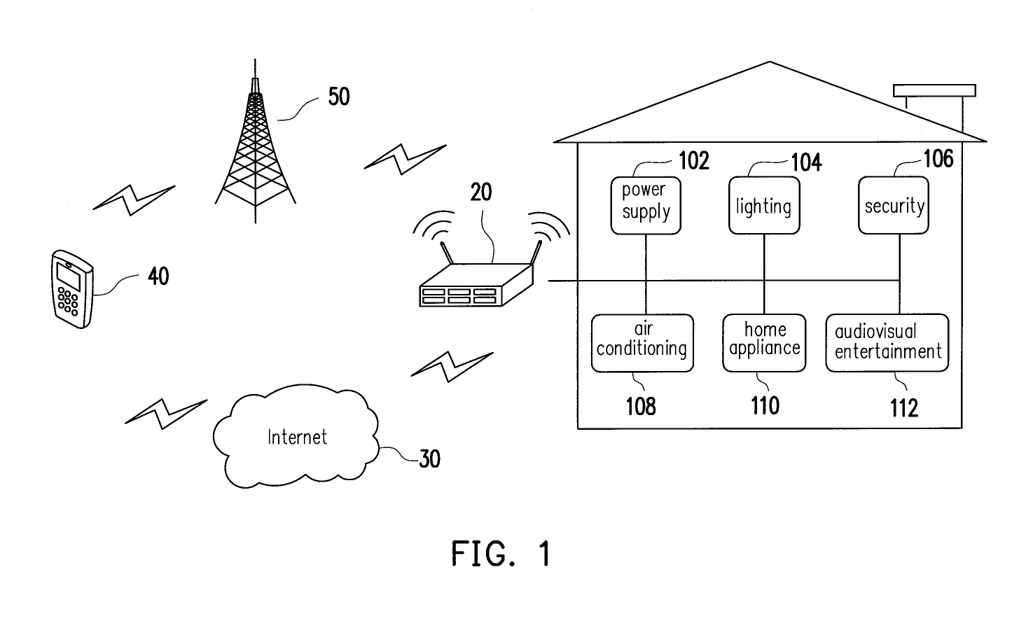

FIG. 1 is a schematic diagram illustrating remote home control according to an exemplary embodiment of the invention.

With reference to FIG. 1, a remote home control environment generally includes household appliances, a home control gateway 20, an Internet 30, a mobile communication device 40, and a mobile phone network 50.

The household appliances include a power supply appliance 102, a lighting appliance 104, a security appliance 106, an air conditioning appliance 108, a home appliance 110, and an audiovisual entertainment appliance 112. However, it should be noted that the household appliances are not limited to the above, and the aforementioned household appliances should not be construed to limit the invention. For example, the power supply appliance 102, the lighting appliance 104, the security appliance 106, the air conditioning appliance 108, the home appliance 110, and the audiovisual entertainment appliance 112 respectively include a control chip or a control circuit for receiving a control command from the home control gateway 20 and executing a corresponding functional operation according to the control command.

The home control gateway 20 includes one or a plurality of communication channels, through which the user can communicate with the home control gateway 20 for remote control.

The Internet 30 is a communication network established according to an Internet protocol transmission standard. The home control gateway 20 may communicate with other electronic devices with Internet connection capability through the Internet 30. For example, the Internet protocol transmission standard is the transmission control protocol/Internet protocol (TCP/IP) or user datagram protocol/Internet protocol (UDP/IP).

The mobile communication device 40 is a mobile communication appliance used by the user, which includes a subscriber identity module card (SIM card). The mobile communication device 40 is a cell phone, a personal digital assistant (PDA) phone, or a smart phone, for example. The invention is not intended to limit the type of the mobile communication device 40.

The mobile phone network 50 is a telecommunication service provided by a telecommunication service provider, such as global system for mobile communications (GSM), code division multiple access (CDMA), and personal handy-phone system (PHS).

In this exemplary embodiment, the mobile communication device 40 communicates with the home control gateway 20 through the mobile phone network 50 by a short message service (SMS) or voice. In addition, after being verified, the mobile communication device 40 may perform remote control on the power supply appliance 102, the lighting appliance 104, the security appliance 106, the air conditioning appliance 108, the home appliance 110, and the audiovisual entertainment appliance 112 through the communication channel established by the home control gateway 20 by means of a web control interface or an application (APP) interface.

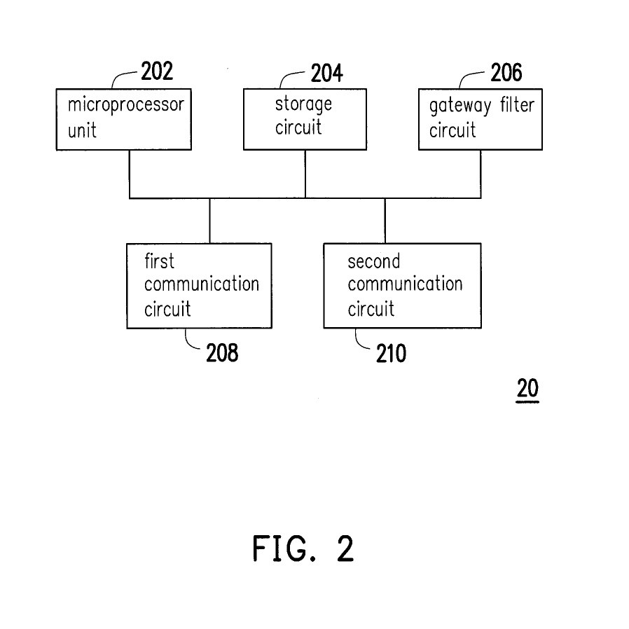

FIG. 2 is a block diagram illustrating a home control gateway according to an exemplary embodiment of the invention.

With reference to FIG. 2, the home control gateway 20 includes a microprocessor unit 202, a storage circuit 204, a gateway filter circuit 206, a first communication circuit 208, and a second communication circuit 210.

The microprocessor unit 202 is hardware with computing capability (e.g. a chip set, a processor, etc.) for controlling the overall operation of the home control gateway 20. In this exemplary embodiment, the microprocessor unit 202 is a central processing unit (CPU), a programmable microprocessor, a digital signal processor (DSP), a programmable controller, an application specific integrated circuit (ASIC), a programmable logic device (PLD), or other similar devices, for example.

The storage circuit 204 is coupled to the microprocessor unit 202. The storage circuit 204 may be an embedded storage unit or an external storage unit. The embedded storage unit may be a random access memory (RAM), a read-only memory (ROM), a flash memory, a magnetic disk storage device, etc. The external storage unit may be a compact flash (CF) memory card, a secure digital (SD) memory card, a micro SD memory card, a memory stick (MS), etc. More specifically, in this exemplary embodiment of the invention, the storage circuit 204 is configured to store a mobile communication device number database (not shown) and store one or a plurality of programs, applications, or operating systems for controlling the operation of the home control gateway 20. The mobile communication device number database stores one or a plurality of master mobile communication device numbers in advance. For example, in an exemplary embodiment, the home control gateway 20 records the master mobile communication device number in a machine learning manner. Further, in another exemplary embodiment of the invention, the user manually inputs and stores phone numbers in advance to the mobile communication device number database in the storage circuit 204 through a web page, an application (APP), or phone voice.

The gateway filter circuit 206 is coupled to the microprocessor unit 202 for generating a token. The token is a unique identifier, and a different token is generated every time. In an exemplary embodiment of the invention, the token is generated according to a fixed rule. When the token is to be generated, the gateway filter circuit 206 performs an encryption algorithm according to a content value of a counter to generate one token, and simultaneously adds 1 to the content value of the counter and responds with the generated token. In another exemplary embodiment of the invention, a method of generating the token may include directly responding with the content value of the counter, namely, responding with the content value of the counter every time the token is requested and adding 1 to the content value of the counter without performing the encryption algorithm. In addition, in another exemplary embodiment of the invention, the token is generated randomly according to a random number algorithm and may include English letters, numbers, or symbols with no limitation to the length. It should be noted that any method suitable for generating the token is applicable to the invention, and the invention is not limited to the aforementioned token generation mechanism.

In another exemplary embodiment of the invention, the gateway filter circuit 206 is implemented in the form of a circuit. However, the invention is not limited thereto. For example, the function of the gateway filter circuit 206 may also be implemented in the form of codes to be stored in the storage circuit 204. Moreover, when the home control gateway 20 is powered, the microprocessor unit 202 runs the codes to execute the function of the gateway filter circuit 206.

The first communication circuit 208 is coupled to the microprocessor unit 202 and operates according to a transmission standard or a protocol compatible to the mobile phone network 50. For example, the first communication circuit 208 may transmit or receive a short message or a voice signal through the mobile phone network 50.

The second communication circuit 210 is coupled to the microprocessor unit 202 and operates according to a transmission standard or a protocol compatible to the

Internet 30 to transmit or receive a packet through the Internet 30.

In an exemplary embodiment of the invention, when the user intends to initiate remote home control, the user needs to make a call to the home control gateway 20 through the mobile communication device 40, and the home control gateway 20 identifies this calling number according to the calling signal without answering the call and determines whether the calling number is stored in the mobile communication device number database in the storage circuit 204. In particular, after the home control gateway 20 confirms that the calling number is recorded in the mobile communication device number database, a token is generated and a short message including the token is transmitted to the mobile communication device 40. Next, the mobile communication device 40 transmits a connection request including the token to the home control gateway 20 through the Internet 30 to establish a communication channel, so as to perform remote control on the power supply appliance 102, the lighting appliance 104, the security appliance 106, the air conditioning appliance 108, the home appliance 110, and the audiovisual entertainment appliance 112 through the established communication channel.

More specifically, the first communication circuit 208 receives a first calling signal (not shown) from the mobile communication device 40 through the mobile phone network 50 and identifies the phone number of the mobile communication device 40 according to the first calling signal. If the gateway filter circuit 206 determines that the phone number of the mobile communication device 40 already exists in the mobile communication device number database in the storage circuit 204, the phone number is identified as a mobile communication device number for controlling the home control gateway 20. Further, the first communication circuit 208 generates a short message according to the token generated by the gateway filter circuit 206 and transmits the short message including the token to the mobile communication device 40 through the mobile phone network 50.

Then, when the second communication circuit 210 receives the connection request including the token from the mobile communication device 40 through the Internet 30, the gateway filter circuit 206 allows the second communication circuit 210 to establish the communication channel with the mobile communication device 40 according to the token in the packet. Accordingly, the mobile communication device 40 connects to the home control gateway 20 by the established communication channel for performing remote control on the power supply appliance 102, the lighting appliance 104, the security appliance 106, the air conditioning appliance 108, the home appliance 110, and the audiovisual entertainment appliance 112 controlled by the home control gateway 20.

In addition, in an exemplary embodiment of the invention, if the user intends to end the home control operation, the user makes another call to the hone control gateway 20 through the mobile communication device 40 to end the control. More specifically, after the mobile communication device 40 and the second communication circuit 210 establish the communication channel therebetween through the Internet 30, if the first communication circuit 208 receives the calling signal from the mobile communication device 40 through the mobile phone network 50, the gateway filter circuit 206 cuts the communication channel established between the mobile communication device 40 and the second communication circuit 210 through the

Internet 30. In other words, under the condition that the communication channel is cut, even if the received packet includes the token, the gateway filter circuit 206 still blocks the packet.

It is worth mentioning that, in another exemplary embodiment of the invention, if the user intends to end the home control operation, the user may transmit a short message to the home control gateway 20 instead making another call to the home control gateway 20. More specifically, after the mobile communication device 40 and the second communication circuit 210 establish the communication channel therebetween through the Internet 30, if the first communication circuit 208 receives the short message from the mobile communication device 40 through the mobile phone network 50, the gateway filter circuit 206 cuts the communication channel established between the mobile communication device 40 and the second communication circuit 210 through the Internet 30.

It should be noted that, in an exemplary embodiment of the invention, a mobile communication device of a manager (referred to as “master mobile communication device” hereinafter) may authorize another phone number to establish a communication channel with the home control gateway 20 by a short message. More specifically, the master mobile communication device transmits the short message including the phone number that is to be authorized to the home control gateway 50 through the mobile phone network 50. When the first communication circuit 208 of the home control gateway 20 receives the short message through the mobile phone network 50, the gateway filter circuit 206 identifies the phone number from which the short message is transmitted. After performing data comparison with the mobile communication device number database and confirming that the mobile communication device that transmits the short message is the master mobile communication device, the gateway filter circuit 206 adds the phone number that is to be authorized in the short message to the mobile communication device number database in the storage circuit 204, thereby authorizing more phone numbers to be connected with the home control gateway 20.

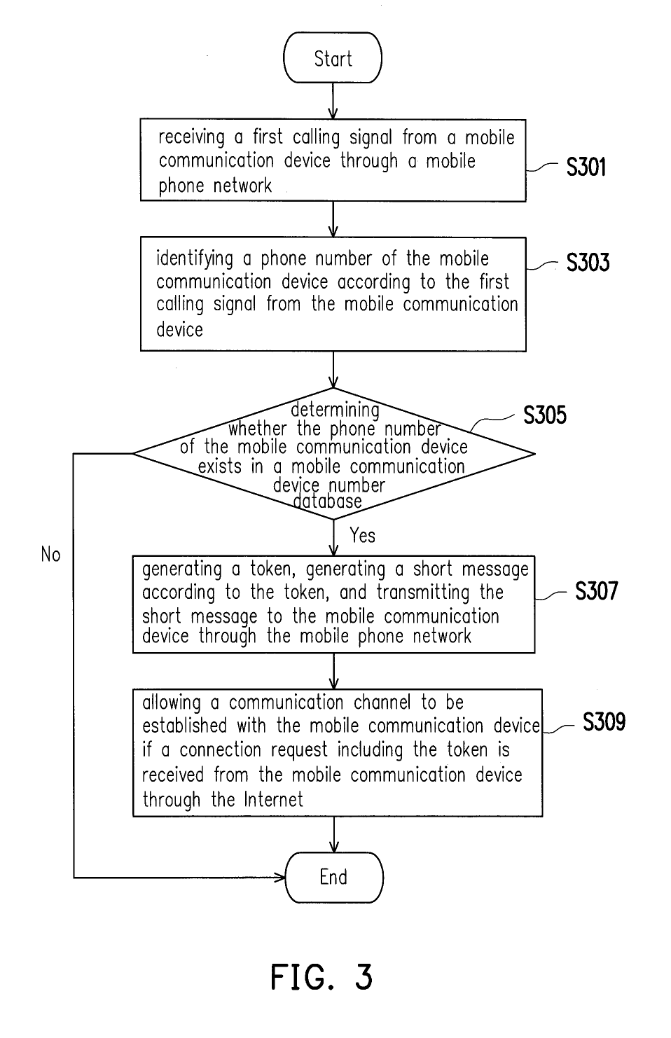

FIG. 3 is a flowchart illustrating a home control network connection method according to an exemplary embodiment of the invention.

With reference to FIG. 3, first, as shown in Step S301, the first communication circuit 208 receives a calling signal (referred to as “first calling signal” hereinafter) from the mobile communication device 40 through the mobile phone network 50. Next, in Step S303, the first communication circuit 208 identifies the phone number of the mobile communication device 40 according to the first calling signal from the mobile communication device 40. Further, in Step S305, the gateway filter circuit 206 determines whether the phone number of the mobile communication device 40 exists in the mobile communication device number database in the storage circuit 204. If the phone number of the mobile communication device 40 exists in the mobile communication device number database in the storage circuit 204, in Step S307, the gateway filter circuit 206 generates a token, and the first communication circuit 208 generates a short message according to the token and transmits the short message to the mobile communication device 40 through the mobile phone network 50.

Thereafter, in Step S309, when the second communication circuit 210 receives a connection request including the token from the mobile communication device 40 through the Internet 30, the gateway filter circuit 206 allows the second communication circuit 210 to establish the communication channel with the mobile communication device 40. Therefore, the mobile communication device verified and authorized by the home control gateway 20 can transmit the short message including the token obtained through verification to establish the communication channel, thereby performing remote control on the home control gateway 20 and the household appliances controlled by the home control gateway 20.

To conclude the above, the home control gateway and the home control network connection method of the embodiments of the invention identify the user identity by verifying the phone number and allow the mobile communication device to establish the communication channel with the home control gateway according to the generated token, such that the user can control the household appliances remotely through the mobile communication device in a simple, easy, convenient, and secure way.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. A home control gateway, comprising:
a microprocessor unit;
a first communication circuit coupled to the microprocessor unit, wherein the first communication circuit receives a first calling signal from a mobile communication device through a mobile phone network;
a second communication circuit coupled to the microprocessor unit;
a gateway filter circuit coupled to the microprocessor unit; and
a storage circuit coupled to the microprocessor unit,
wherein the storage circuit stores a mobile communication device number database,
wherein the first communication circuit identifies a phone number of the mobile communication device according to the first calling signal of the mobile communication device, and the gateway filter circuit determines whether the phone number of the mobile communication device exists in the mobile communication device number database,
wherein if the phone number exists in the mobile communication device number database, the gateway filter circuit generates a token, and the first communication circuit generates a short message according to the token and transmits the short message to the mobile communication device through the mobile phone network, and
wherein if the second communication circuit receives a connection request comprising the token from the mobile communication device through an Internet, the gateway filter circuit allows the second communication circuit to establish a communication channel with the mobile communication device.

2. The home control gateway according to claim 1, wherein after the mobile communication device establishes the communication channel with the second communication circuit through the Internet, the first communication circuit receives a second calling signal from the mobile communication device through the mobile phone network, and
wherein the gateway filter circuit cuts the communication channel established between the mobile communication device and the second communication circuit through the Internet in response to the second calling signal.

3. The home control gateway according to claim 1, wherein after the mobile communication device establishes the communication channel with the second communication circuit through the Internet, the first communication circuit receives a short message from the mobile communication device through the mobile phone network, and
wherein the gateway filter circuit cuts the communication channel established between the mobile communication device and the second communication circuit through the Internet in response to the short message from the mobile communication device.

4. The home control gateway according to claim 1, wherein the gateway filter circuit generates the token randomly or according to a fixed rule.

5. The home control gateway according to claim 1, wherein the first communication circuit receives a short message from a master mobile communication device through the mobile phone network,
wherein the short message from the master mobile communication device comprises at least one other phone number, and
wherein the gateway filter circuit adds the at least one phone number in the short message from the master mobile communication device to the mobile communication device number database.

6. A home control network connection method, executed by a home control gateway, the home control network connection method comprising:
receiving a first calling signal from a mobile communication device through a mobile phone network;
identifying a phone number of the mobile communication device according to the first calling signal of the mobile communication device;
determining whether the phone number of the mobile communication device exists in a mobile communication device number database;
generating a token, generating a short message according to the token, and transmitting the short message to the mobile communication device through the mobile phone network if the phone number exists in the mobile communication device number database; and
allowing the mobile communication device to establish a communication channel if a connection request comprising the token is received from the mobile communication device through an Internet.

7. The home control network connection method according to claim 6, further comprising:
receiving a second calling signal from the mobile communication device through the mobile phone network after the mobile communication device establishes the communication channel with the second communication device through the Internet; and
cutting the communication channel established between the mobile communication device and the second communication circuit through the Internet in response to the second calling signal.

8. The home control network connection method according to claim 6, further comprising:
receiving a short message from the mobile communication device through the mobile phone network after the mobile communication device establishes the communication channel with the second communication circuit through the Internet; and
cutting the communication channel established between the mobile communication device and the second communication circuit through the Internet in response to the short message from the mobile communication device.

9. The home control network connection method according to claim 6, wherein the step of generating the token comprises generating the token randomly or according to a fixed rule.

10. The home control network connection method according to claim 6, further comprising:
receiving a short message from a master mobile communication device through the mobile phone network, wherein the short message from the master mobile communication device comprises at least one other phone number; and
adding the at least one other phone number in the short message from the master mobile communication device to the mobile communication device number database.
